(19) United States
(12) Patent Application Publication
(10) Pub. No.: US 2026/0360130 A1
(43) Pub. Date: Nov. 12, 2026

(54) IMAGE SELECTION APPARATUS, IMAGE SELECTION METHOD, AND STORAGE MEDIUM

(71) Applicant: NEC Corporation, Tokyo (JP)

(72) Inventors: Daisuke KUWAHARA, Tokyo (JP); Shin TOMINAGA, Tokyo (JP); Kazutoshi SAGI, Tokyo (JP)

(73) Assignee: NEC Corporation, Tokyo (JP)

(21) Appl. No.: 19/488,109

(22) PCT Filed: May 29, 2024
(86) PCT No.: PCT/JP2024/019723

§ 371 Date: Nov. 26, 2025

(30) Foreign Application Priority Data
Jun. 5, 2023 (JP) 2023-092663

(51) Int. Cl. G06V 10/774; G06V 20/54

(52) U.S. Cl. CPC G06V 10/7747; G06V 20/54; G06V 2201/08

(57) ABSTRACT

This image selection apparatus generates training data for generating a first machine learning model, and is provided with at least an acquisition unit and a determination unit. The acquisition unit acquires a first processing result and acquires a second processing result. The first processing result is the result of processing a target image using the first machine learning model. The second processing result is the result of processing executed by a high-precision image processing unit capable of processing the target image with higher precision than the first machine learning model. The determination unit uses the first processing result and the second processing result to determine whether to use the target image as training data for the first machine learning model.

### TECHNICAL FIELD

This application is based upon and claims the benefit of priority from Japanese patent application No. 2023-092663, filed on Jun. 5, 2023, the disclosure of which is incorporated herein in its entirety by reference.

The present invention relates to an image selection apparatus, an image selection method, and a program.

### BACKGROUND ART

In a case where a model is generated by machine learning, training data is often required. PTL 1 describes that a label of training data is determined based on an identification result obtained by a model different from a model to which the training data is applied.

### CITATION LIST

### Patent Literature

PTL 1: WO 2019/215780 A1

### SUMMARY OF INVENTION

### Technical Problem

It is necessary to prepare appropriate training data in order to improve performance of a model generated by machine learning. In a case where such training data is manually prepared, much labor is required. However, it is difficult to reduce this labor in PTL 1 described above.

In view of the above-described problem, an object of the present invention is to provide an image selection apparatus, an image selection method, and a program capable of reducing labor for preparing training data.

### Solution to Problem

An image selection apparatus according to the present disclosure includes:
an acquisition means for acquiring a first processing result that is a result of processing a target image using a first machine learning model, and acquiring a second processing result that is a processing result obtained by a high-precision image processing means capable of processing the target image with higher precision than the first machine learning model; and
a determination means for determining whether to use the target image as training data of the first machine learning model by using the first processing result and the second processing result.

An image processing method according to the present disclosure is an image selection method including:
acquiring, by at least one computer, a first processing result that is a result of processing a target image using a first machine learning model, and acquiring a second processing result that is a processing result obtained by a high-precision image processing means capable of processing the target image with higher precision than the first machine learning model; and
determining, by the at least one computer, whether to use the target image as training data of the first machine learning model by using the first processing result and the second processing result.

A program according to the present disclosure causes at least one computer to function as:
an acquisition means for acquiring a first processing result that is a result of processing a target image using a first machine learning model, and acquiring a second processing result that is a processing result obtained by a high-precision image processing means capable of processing the target image with higher precision than the first machine learning model; and
a determination means for determining whether to use the target image as training data of the first machine learning model by using the first processing result and the second processing result.

### Advantageous Effects of Invention

According to the present disclosure, it is possible to provide the image selection apparatus, the image selection method, and the program capable of reducing the labor for preparing the training data.

### BRIEF DESCRIPTION OF DRAWINGS

FIG. 1 It is a block diagram illustrating a configuration example of an image selection apparatus according to the present disclosure.

FIG. 2 It is a view for describing an example of a first processing result and a second processing result.

FIG. 3 It is a flowchart illustrating a processing operation example of the image selection apparatus according to the present disclosure.

FIG. 4 It is a diagram illustrating an example of a use environment of the image selection apparatus according to the present disclosure.

FIG. 5 It is a block diagram illustrating a configuration example of the image selection apparatus according to the present disclosure.

FIG. 6 It is a block diagram illustrating a hardware configuration example of the image selection apparatus according to the present disclosure.

FIG. 7 It is a flowchart illustrating a processing operation example of the image selection apparatus according to the present disclosure.

FIG. 8 It is a block diagram illustrating a configuration example of an image selection apparatus according to the present disclosure.

FIG. 9 It is a view illustrating an example of a screen output by the image selection apparatus according to the present disclosure.

FIG. 10 It is a flowchart illustrating a processing operation example of the image selection apparatus according to the present disclosure.

FIG. 11 It is a block diagram illustrating a configuration example of an image selection apparatus according to the present disclosure.

FIG. 12 It is a view for describing operation of the image selection apparatus according to the present disclosure.

### EXAMPLE EMBODIMENT

Hereinafter, in the present disclosure, the drawings are associated with one or more example embodiments. In all the drawings, similar components are denoted by similar reference signs, and descriptions thereof will be omitted as appropriate.

### First Example Embodiment

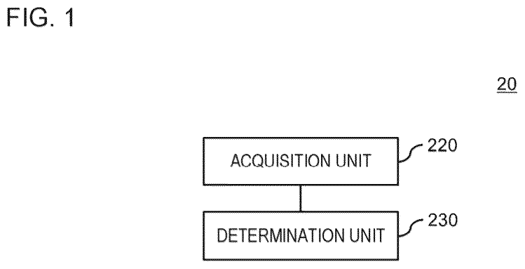

The image selection apparatus 20 is a apparatus that generates training data for generating a first machine learning model, and includes at least an acquisition unit 220 and a determination unit 230 as illustrated in FIG. 1.

The acquisition unit 220 acquires a first processing result and acquires a second processing result. The first processing result is a result of processing a target image using the first machine learning model. The second processing result is a processing result obtained by a high-precision image processing unit that can process the target image with higher precision than the first machine learning model.

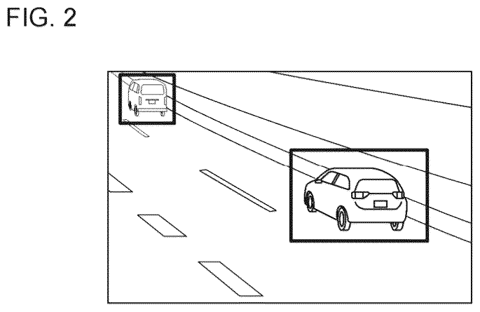

As illustrated in FIG. 2, the first processing result and the second processing result indicate, for example, whether at least one of a specific event and a target object is included in the target image. Examples of the target object include, but are not limited to, at least one of a vehicle such as an automobile, a person, and foreign matter on a road. An example of the specific event is, but is not limited to, a traffic accident or congestion. The first processing result and the second processing result may further include positions of the specific event and the target object in the target image.

Here, an example in which the high-precision image processing unit “can process the target image with higher precision than the first machine learning model” is that at least one of the following is satisfied.
(A) The high-precision image processing unit can detect the event or the target object that cannot be detected by the first machine learning model.
(B) Both the first machine learning model and the high-precision image processing unit perform pre-processing on the target image, but the high-precision image processing unit performs pre-processing that requires a larger processing load than the first machine learning model. An example of the pre-processing used by the high-precision image processing unit is deep learning, a support vector machine (SVM), or a cascade classifier. The SVM requires a smaller amount of computation for processing than deep learning but has a tendency to decrease precision. The cascade classifier also requires a smaller amount of computation for processing than deep learning but has a tendency to decrease precision in the case of being used alone.
(C) The first machine learning model does not perform pre-processing on the target image, but the high-precision image processing unit performs pre-processing. An example of the pre-processing used by the high-precision image processing unit is as illustrated in (B).
(D) In a case where the high-precision image processing unit and the first machine learning model are machine learning, the number of parameters to be used, for example, the number of features is larger in the high-precision image processing unit than in the first machine learning model.
(E) In a case where both the high-precision image processing unit and the first machine learning model use a neural network such as deep learning, the number of at least one of intermediate layers and nodes of the neural network is larger in the high-precision image processing unit than in the first machine learning model.
(F) In a case where both the high-precision image processing unit and the first machine learning model use bagging, the number of algorithms to be used is larger in the high-precision image processing unit than in the first machine learning model.
(G) In a case where both the high-precision image processing unit and the first machine learning model use bagging, precision of an algorithm used in the high-precision image processing unit is equal to or more than precision of an algorithm used in the first machine learning model.

There is a case where both the high-precision image processing unit and the first machine learning model calculate a certainty factor that the event or the target object is shown in the target image, and determine that the event or the target object is shown in the target image in a case where the certainty factor is equal to or more than a reference value. In this case, the reference value used by the high-precision image processing unit and the reference value used by the first machine learning model may be different from each other or may be the same. At least one of the reference value used by the high-precision image processing unit and the reference value used by the first machine learning model may be configured to be settable by a user or a developer of the image selection apparatus 20 via a user interface.

The amount of computation performed by the high-precision image processing unit is usually larger than the amount of computation in the case of using the first machine learning model. Therefore, a processing time taken by the high-precision image processing unit is longer than a processing time in the case of using the first machine learning model.

The determination unit 230 determines whether to use the target image as the training data of the first machine learning model by using the first processing result and the second processing result. As an example, in a case where the target image includes the specific event or the target object according to the second processing result, whereas the target image does not include the event or the target object according to the first processing result, the determination unit 230 determines to use the target image as the training data. The target image determined to be used as the training data by the determination unit 230 is used as the training data for updating the first machine learning model. Here, the training data may include only the target image, or may be data in which an annotation result, for example, the second processing result is associated with the target image as a label.

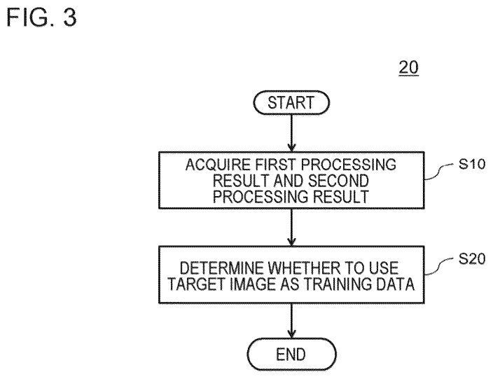

As illustrated in FIG. 3, the acquisition unit 220 of the image selection apparatus 20 acquires the first processing result and acquires the second processing result (step S10). Next, the determination unit 230 of the image selection apparatus 20 uses the first processing result and the second processing result to determine whether to use the target image as the training data of the first machine learning model (step S20). These processes are performed, for example, in a batch format.

According to the image selection apparatus 20, the determination unit 230 determines whether to use the target image as the training data of the first machine learning model by using the first processing result and the second processing result. Therefore, labor required for preparing the training data can be reduced.

Next, a detailed example of a use environment of the image selection apparatus 20 will be described.

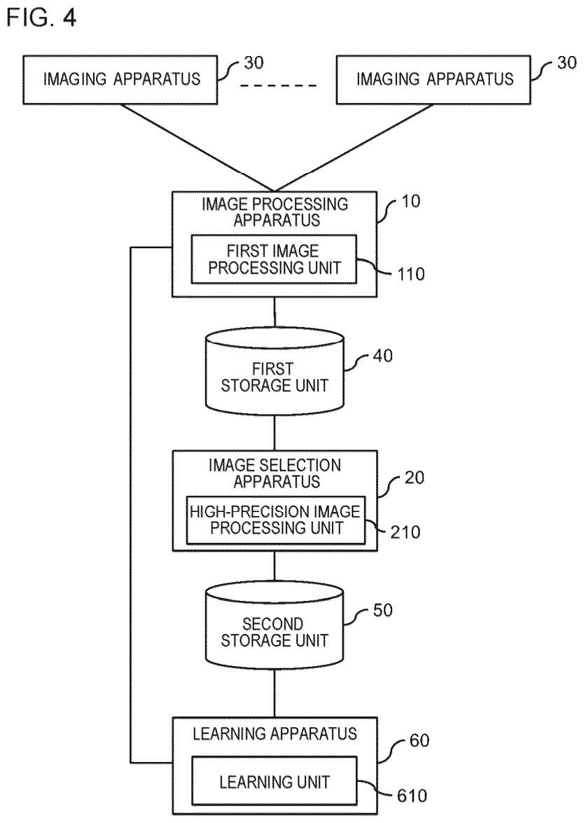

In an example illustrated in FIG. 4, the image selection apparatus 20 is used together with an image processing apparatus 10, at least one imaging apparatus 30, a first storage unit 40, a second storage unit 50, and a learning apparatus 60. The image selection apparatus 20 is often used together with a plurality of imaging apparatuses 30. Although only one image processing apparatus 10 is illustrated in FIG. 4, a plurality of image processing apparatuses 10 may be used for one image selection apparatus 20.

The imaging apparatus 30 generates an image at a predetermined frame rate. As an example, the imaging apparatus 30 is a surveillance camera. An image capturing range of the imaging apparatus 30 may be a road, an entrance of a building, or the inside of a building, for example, the inside of a room. In a case where the imaging apparatus 30 captures an image of a road, a plurality of the imaging apparatuses 30 are arranged along the road. In a case where the plurality of imaging apparatuses 30 are present, each of the imaging apparatuses 30 transmits the generated image to the image processing apparatus 10 in association with identification information of the imaging apparatus 30 and generation date and time. The identification information of the imaging apparatus 30 is used for, for example, specifying an image capturing location. The generation date and time of the image may be generated by the image processing apparatus 10. In this case, for example, the image processing apparatus 10 sets the date and time when the image is acquired from the imaging apparatus 30 as the generation date and time of the image.

The image processing apparatus 10 includes a first image processing unit 110. The first image processing unit 110 processes a target image generated by the imaging apparatus 30 to determine whether a specific event or a target object is included in the target image. At this time, the first image processing unit 110 uses the first machine learning model. Machine learning used for the first machine learning model is, but is not limited to, a neural network such as deep learning, bagging, boosting, or stacking, for example. The first image processing unit 110 stores a processing result obtained by the first machine learning model, that is, a first processing result in the first storage unit 40 together with the target image in association with the target image used as a basis of the first processing result, the generation date and time thereof, and the identification information of the imaging apparatus 30 that has generated the target image.

The imaging apparatus 30 may transmit the target image to the image processing apparatus 10 in real time, and the first image processing unit 110 of the image processing apparatus 10 may process the target image in real time. In this case, since the first image processing unit 110 generates the first processing result each time the target image is generated, it is necessary to process the target image quickly, that is, in a short time. Therefore, it is difficult to increase a processing amount of the first image processing unit 110 in order to improve processing accuracy.

The image selection apparatus 20 reads the target image and the first processing result from the first storage unit 40. Then, the image selection apparatus 20 includes a high-precision image processing unit 210. The high-precision image processing unit 210 processes the target image to generate a second processing result. As described above, the second processing result is generated after the first processing result. A processing amount necessary for generating the second processing result is larger than the processing amount necessary for generating the first processing result. Then, the image selection apparatus 20 determines whether to use the target image as the training data by using the read first processing result and the generated second processing result, and stores, in the second storage unit 50, information that can specify the target image determined to be used as the training data. As an example, the image selection apparatus 20 stores the target image in the second storage unit 50 as at least a part of the training data.

The learning apparatus 60 includes a learning unit 610. The learning unit 610 updates the first machine learning model by using the target image selected by the image selection apparatus 20 as at least a part of the training data, and stores the updated first machine learning model in the image processing apparatus 10. Then, the image processing apparatus 10 processes the target image by using the updated first machine learning model.

The image selection apparatus 20 may include the first image processing unit 110, may include the learning unit 610, or may include both the first image processing unit 110 and the learning unit 610. The image selection apparatus 20 may be integrated with at least one of the first storage unit 40 and the second storage unit 50. The image selection apparatus 20 may directly acquire the target image from the imaging apparatus 30.

Next, a detailed example of a configuration of the image selection apparatus 20 will be described.

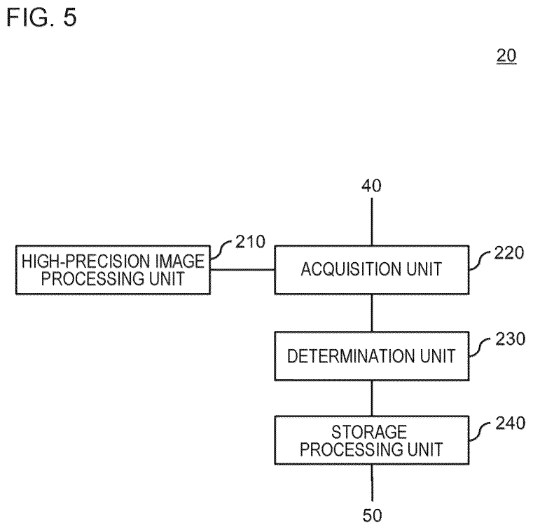

In the example illustrated in FIG. 5, the image selection apparatus 20 includes the high-precision image processing unit 210 and a storage processing unit 240 in addition to the acquisition unit 220 and the determination unit 230.

The high-precision image processing unit 210 processes the target image to generate the second processing result. The high-precision image processing unit 210 generates the second processing result of processing the target image using, for example, the second machine learning model. Machine learning used for the second machine learning model is, but is not limited to, a neural network such as deep learning, bagging, boosting, or stacking, for example. In addition, the high-precision image processing unit 210 may generate the second processing result without using the second machine learning model. As an example, the high-precision image processing unit 210 may generate the second processing result by feature extraction or pattern matching.

The acquisition unit 220 and the determination unit 230 are as described with reference to FIG. 1.

The storage processing unit 240 causes the second storage unit 50 to store information capable of specifying the target image determined to be used as the training data of the first machine learning model by the determination unit 230. As a result, the training data can be generated by using the second storage unit 50. The information that can specify the target image may be the target image itself or may be information indicating the imaging apparatus 30 that has generated the target image and the generation date and time.

The storage processing unit 240 may generate training data and store the training data in the second storage unit 50. For example, the storage processing unit 240 generates the training data by using a target image and a second processing result of the target image. An example of the training data includes a target image and at least a part of a second processing result of the target image. The at least part of the second processing result of the target image is used as at least a part of a label of the target image. An example of the at least part of the second processing result may be at least one of a position of a target object in the target image and an occurrence position of an event, at least one of a type of the target object and a type of the event, or both of these positions and types. The “position” used here is not necessarily a point, and may have a certain area. The label may include information input by the user or the developer of the image selection apparatus 20. For example, the storage processing unit 240 acquires this information via the user interface of the image selection apparatus 20.

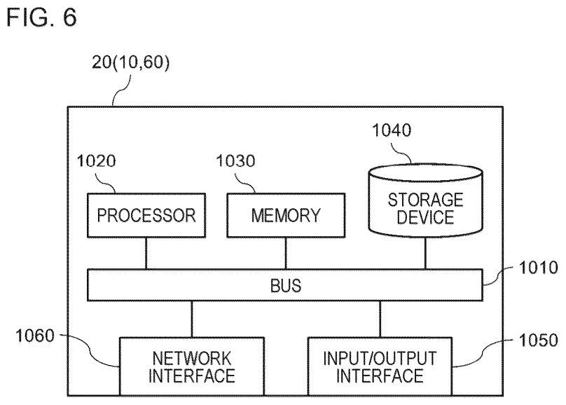

As illustrated in FIG. 6, for example, the image selection apparatus 20 includes a bus 1010, a processor 1020, a memory 1030, a storage device 1040, an input/output interface 1050, and a network interface 1060 as hardware.

The bus 1010 is a data transmission path for the processor 1020, the memory 1030, the storage device 1040, the input/output interface 1050, and the network interface 1060 to transmit and receive data to and from each other. However, a method for connecting the processor 1020 and the like to each other is not limited to bus connection.

The processor 1020 is a processor achieved by a central processing unit (CPU), a graphics processing unit (GPU), or the like.

The memory 1030 is a main storage device achieved by a random access memory (RAM) or the like.

The storage device 1040 is an auxiliary storage device achieved by a removable medium such as a hard disk drive (HDD), a solid state drive (SSD), and a memory card, or a read only memory (ROM), and has a recording medium. The recording medium of the storage device 1040 stores program modules that implement functions (for example, the high-precision image processing unit 210, the acquisition unit 220, the determination unit 230, and the storage processing unit 240) of the image selection apparatus 20. The processor 1020 implements the functions associated to the program modules by reading and executing the program modules on the memory 1030. The storage device 1040 may function as at least one of the first storage unit 40 and the second storage unit 50.

The input/output interface 1050 is an interface for connecting the image selection apparatus 20 and various input/output devices.

The network interface 1060 is an interface for connecting the image selection apparatus 20 to a network. The network is, for example, a local area network (LAN) or a wide area network (WAN). A method for connecting the network interface 1060 to the network may be wireless connection or wired connection. The image selection apparatus 20 may communicate with at least one of the image processing apparatus 10, the imaging apparatus 30, the first storage unit 40, the second storage unit 50, and the learning apparatus 60 via the network interface 1060.

The image selection apparatus 20 may be achieved by a plurality of devices each having a configuration illustrated in FIG. 6.

Hardware configurations of the image processing apparatus 10 and the learning apparatus 60 are also similar to a hardware configuration of the image selection apparatus 20 illustrated in FIG. 6.

Next, a detailed example of processing performed by the image selection apparatus 20 will be described. In the example described below, an operation timing of the image selection apparatus 20 is not synchronized with an operation timing of the image processing apparatus 10. Then, the image selection apparatus 20 operates periodically and processes an unprocessed target image.

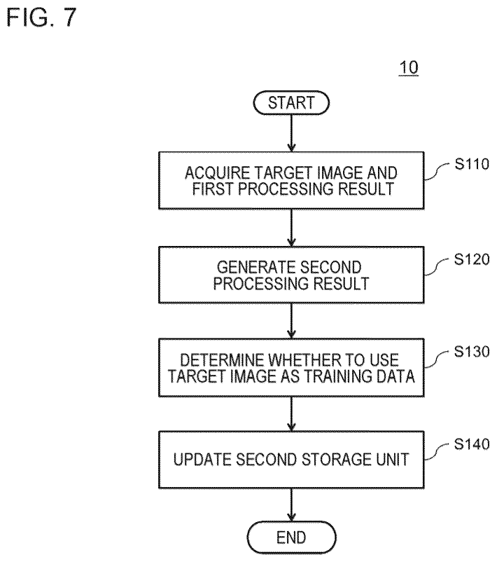

For example, as illustrated in FIG. 7, the acquisition unit 220 of the image selection apparatus 20 acquires an unprocessed target image and a first processing result associated with the target image from the first storage unit 40 (step S110). Next, the high-precision image processing unit 210 processes the target image acquired by the acquisition unit 220 to generate a second processing result (step S120). The acquisition unit 220 acquires the second processing result. Next, the determination unit 230 determines whether to use the target image processed this time as training data by using the first processing result and the second processing result acquired by the acquisition unit 220 (step S130).

Then, the determination unit 230 updates the second storage unit 50 by using the target image determined to be used as the training data in step S130 (step S140). A specific example of processing performed here is as described with reference to FIG. 5.

As described above, in a case where the image selection apparatus 20 is used, the determination unit 230 determines whether to use the target image as the training data of the first machine learning model by using the first processing result and the second processing result. Therefore, labor required for preparing the training data can be reduced. In a case where the storage processing unit 240 of the image selection apparatus 20 stores the target image and at least a part of the second processing result in the second storage unit 50 as at least a part of the training data, it is possible to further reduce the labor required for preparing the training data.

### Second Example Embodiment

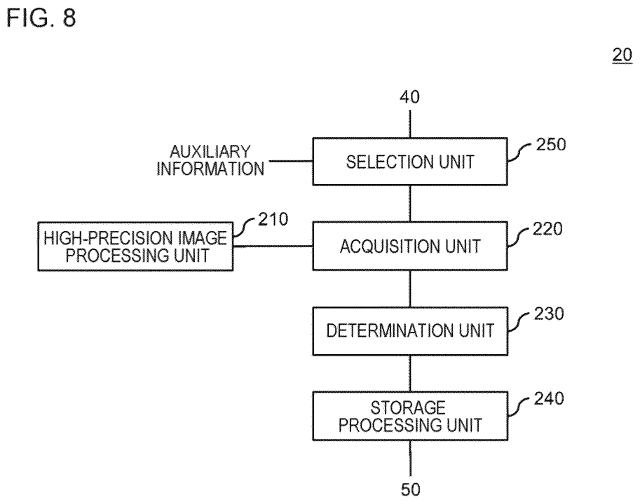

The image selection apparatus 20 illustrated in FIG. 8 includes a selection unit 250 in addition to the image selection apparatus 20 illustrated in FIG. 5. The selection unit 250 selects a target image from images generated by the imaging apparatus 30 by using auxiliary information. The high-precision image processing unit 210, the acquisition unit 220, and the determination unit 230 perform processing on the target image selected by the selection unit 250. In this manner, it is possible to reduce a processing amount of the high-precision image processing unit 210, the acquisition unit 220, and the determination unit 230 while maintaining the quality of training data generated using the image selection apparatus 20.

Also in this case, the first image processing unit 110 of the image processing apparatus 10 preferably performs processing on all images generated by the imaging apparatus 30.

Specific examples of the auxiliary information are as follows.
(1) The auxiliary information includes at least one of an image capturing location, an image capturing timing, and weather information during image capturing of the target image.
(2) The auxiliary information includes information input through a user interface. A type of the information input via the user interface may be, for example, at least one of the image capturing location, the image capturing timing, and the weather information during image capturing of the target image illustrated in (1) above.
(3) In a case where the imaging apparatus 30 generates an image by capturing an image of a road, the auxiliary information includes information regarding a situation of the road.

Among pieces of the auxiliary information described in (1) above, the “image capturing location” is, for example, an image capturing location that satisfies a specific condition, that is, an image capturing range of the imaging apparatus 30. In a case where the plurality of imaging apparatuses 30 are arranged along the road, an example of the “image capturing location” used as the auxiliary information is a location where at least one of the number of accidents per unit period, the number of occurrences of congestion per unit period, the presence of a stopped vehicle, the number of detections of a wrong-way vehicle, the number of detections of a vehicle traveling at a predetermined speed or less, the number of detections of a vehicle traveling at a legal speed or higher, the number of detections of a fleeing vehicle, and traffic volume of moving bodies such as vehicles satisfies a criterion. At least one of the number of accidents per unit period, the number of occurrences of traffic congestion per unit period, and the traffic volume of moving bodies such as vehicles used here is generated by processing an image generated by the imaging apparatus 30, for example. This processing may be performed by the first image processing unit 110 of the image processing apparatus 10 or the high-precision image processing unit 210 of the image selection apparatus 20. A specific example of the moving body is at least one of a pedestrian and specific vehicles such as a bicycle, a motorcycle, and a truck. Then, the selection unit 250 selects an image satisfying the “image capturing location” as the target image. The image capturing location is specified using identification information of the image processing apparatus 10 that has generated the image. This identification information is stored in the first storage unit 40, for example.

The “image capturing timing” among pieces of the auxiliary information described in (1) includes, for example, at least one of a specific month, a specific day of the week, a specific season, and a specific time zone. An example of the specific day of the week is at least one of a weekday, a holiday, and a national holiday. An example of the specific time zone is a time zone related to at least one of morning, evening, and night. Then, the selection unit 250 selects an image satisfying the “image capturing timing” as the target image. The generation date and time of the image is stored in the first storage unit 40, for example.

The “weather information during image capturing” among pieces of the auxiliary information described in (1) above indicates that, for example, an image captured in specific weather is selected as the target image. Here, an example of the specific weather is at least one of rain, fog, snow, and strong wind. In this example, the selection unit 250 may acquire, for example, weather information related to the image capturing date and time and the image capturing location as the weather information of the image generated by the imaging apparatus 30 from a server that stores past weather or the like. The server may acquire and store the weather information related to the image capturing date and time and the image capturing location from a sensor installed together with the imaging apparatus 30. In this case, the server may be managed by an organization that manages the image processing apparatus 10, the image selection apparatus 20, and the learning apparatus 60. This server may be managed by a public institution such as the Meteorological Agency.

As the auxiliary information, information generated by a sensor having a low correlation with the weather, for example, a distance measuring sensor such as LiDAR or an ultrasonic sensor, an infrared sensor, or an infrared camera may be used.

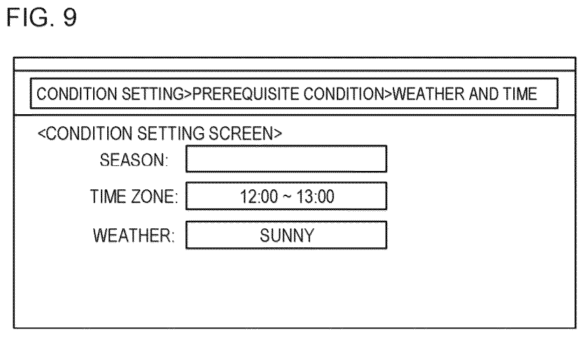

The user interface illustrated in (2) above includes a field indicating a state in which the auxiliary information can be selected by the user of the image selection apparatus 20, for example, a field for allowing the user to select the auxiliary information in a pull-down format as in a screen illustrated in FIG. 9. On the screen illustrated in FIG. 9, each of the season, the time zone, and the weather information is selected in a pull-down format.

The “information regarding the situation of the road” described in (3) above includes, for example, at least one of the degree of congestion of the road, the presence or absence and a type of a traffic restriction, the presence or absence of foreign matter such as a fallen object, and a type of the road. The degree of congestion of the road in a case where the image has been generated may be specified using, for example, history information of traffic congestion stored in an external server, or may be specified by processing the image generated by the imaging apparatus 30. The type of the road includes at least one of a general road, a road on which only specific vehicles are permitted to pass, such as an expressway, and a toll road. The type of the road may be associated in advance with the identification information of the imaging apparatus 30, for example.

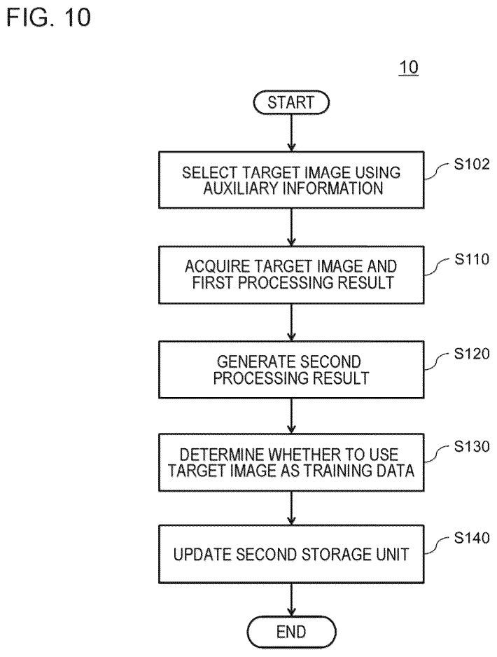

The image selection apparatus 20 illustrated in FIG. 8 operates as illustrated in FIG. 10, for example. First, the selection unit 250 acquires auxiliary information, and selects a target image from images stored in the first storage unit 40 by using the auxiliary information (step S102). The subsequent processing, for example, steps S110 to S140, is as described with reference to FIG. 7.

The storage processing unit 240 may cause a display device viewed by the user of the image selection apparatus 20 to display the auxiliary information used for selecting the target image together with at least one of the image selected as the target image and the image not selected as the target image.

The processing accuracy of the first machine learning model used by the image processing apparatus 10 may decrease in an image captured under a specific condition. In this regard, the image selection apparatus 20 can select an image satisfying this specific condition as the target image, it is possible to increase training data satisfying this condition. Therefore, in a case where the image selection apparatus 20 is used, weaknesses of the first machine learning model can be reduced.

In a case where it is desired to preferentially increase processing accuracy of an image satisfying a specific condition, for example, in a case where it is desired to increase detection accuracy of a vehicle in a place where the probability of occurrence of an accident is high, the use of the image selection apparatus 20 enables the first machine learning model to preferentially learn training data satisfying this specific condition.

### Third Example Embodiment

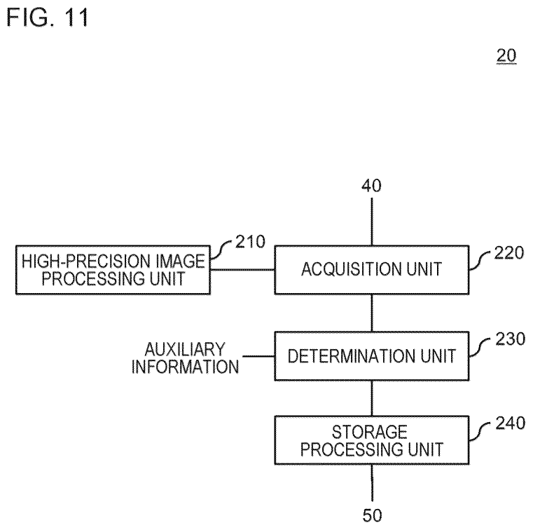

In the image selection apparatus 20 illustrated in FIG. 11, the determination unit 230 further uses auxiliary information in a case of determining whether to use a target image as training data. Examples of the auxiliary information to be used first include (1) to (3) described with reference to FIGS. 8 and 9.

In this case, for example, the determination unit 230 determines whether the target image is usable as the training data by using the auxiliary information, and performs determination processing using a first processing result and a second processing result on the target image determined to be usable here. As another example, the determination unit 230 determines whether the target image is usable as the training data by using the first processing result and the second processing result, and performs determination processing using the auxiliary information on the target image determined to be usable here.

The “determination processing using the auxiliary information” is, for example, similar to processing in which the selection unit 250 illustrated in FIG. 8 selects the target image, and here, a condition for selecting the target image is a condition for determining that the target image is usable as the training data.

The auxiliary information used in the image selection apparatus 20 further includes the following (4).

(4) The auxiliary information is based on at least a part of the second processing result.

In this case, for example, the auxiliary information is that an event or a target object to be detected in the second processing result has been detected. In this case, only on a target image in which the event or the target object has been detected in the second processing result, the determination unit 230 performs determination on whether the target image is usable as the training data by using the first processing result and the second processing result.

As another example, the auxiliary information includes a comparison result of the first processing result with respect to the second processing result. For example, in a case where a target image includes a plurality of events or target objects according to the second processing result, the determination unit 230 determines that the target image is usable as the training data in a case where the ratio of the number of events or targets indicated by the first processing result to the number of the plurality of events or targets indicated by the second processing result, that is, a detection rate of the first image processing unit 110 with the second processing result as ground truth is equal to or less than a reference value. For example, in a case where three target objects appear in the target image, but the first image processing unit 110 has detected only one target object, the detection rate is ⅓.

Although being related to the auxiliary information described in (4) above, the following (4-1) may be used as the auxiliary condition.

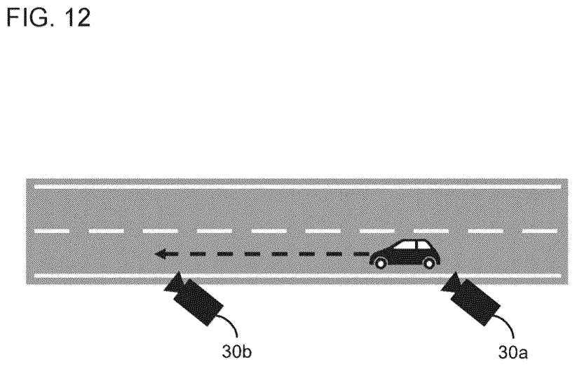

(4-1) It is assumed that the imaging apparatus 30 captures an image of a road to generate the image, and a plurality of the imaging apparatuses 30 are arranged along the road as illustrated in FIG. 12. In a case where a moving body is not detected in the second processing result related to an imaging apparatus 30a that has generated the target image, the auxiliary information includes whether the moving body is detected in the second processing result related to an image generated at a predetermined timing by an imaging apparatus 30b different from the imaging apparatus 30a. The predetermined timing used here is a timing determined based on a generation timing of the target image, and is set by an administrator of the image selection apparatus 20, for example.

Specifically, an interval L between the imaging apparatus 30a and the imaging apparatus 30b is known. The speed of the moving body between the imaging apparatus 30a and the imaging apparatus 30b, for example, the speed of a vehicle also falls within a range of equal to or more than V₁ and equal to or less than V₂ to some extent. Therefore, the time from when the moving body appears in the image generated by the imaging apparatus 30a to when the moving body appears in the image generated by the imaging apparatus 30b is highly likely to be equal to or more than L/V₂ and equal to or less than L/V₁.

For example, it is assumed that the imaging apparatus 30b is installed on the downstream side of the imaging apparatus 30a. Then, it is assumed that the high-precision image processing unit 210 determines that the moving body does not appear in the target image generated by the imaging apparatus 30a, whereas the high-precision image processing unit 210 determines that the moving body is included in the image generated by the imaging apparatus 30b about equal to or more than L/V₂ and equal to or less than L/V₁ after the generation timing of the target image. In this case, there is a possibility that the second processing result of the target image generated by the imaging apparatus 30a is wrong. Therefore, the determination unit 230 determines that the target image is to be used as the training data.

In this case, the storage processing unit 240 stores the target image in the second storage unit 50, but a label of the training data is not generated at this stage. This label is set, for example, by a person who has viewed the target image stored in the second storage unit 50.

In a case where the imaging apparatus 30b is installed on the upstream side of the imaging apparatus 30a, the image of the imaging apparatus 30b used for this processing is an image generated about equal to or more than L/V₂ and equal to or less than L/V₁ before the generation timing of the target image.

The image selection apparatus 20 also selects an image satisfying a specific condition as the target image, and thus increases training data satisfying this condition. Therefore, in a case where the image selection apparatus 20 is used, weaknesses of the first machine learning model can be reduced. In a case where the image selection apparatus 20 is used, it is possible to cause the first machine learning model to preferentially learn training data satisfying a specific condition.

Although the present disclosure has been described hitherto with reference to example embodiments, the present disclosure is not limited to the example embodiments described above. Various modifications, which can be understood by those skilled in the art, can be made to the configuration and details of the present disclosure within the scope of the present disclosure. Each example embodiment can be appropriately combined with another example embodiment.

In the plurality of flowcharts used in the above description, a plurality of steps (processes) are described in order, but the execution order of the steps executed in each example embodiment is not limited to the described order. In each example embodiment, the order of the illustrated steps can be changed as long as there is no problem in terms of content. The above-described example embodiments can be combined unless otherwise contradicted in content.

Some or all of the example embodiments described above may be described as the following Supplementary Notes, but are not limited to the following.

1. An image selection apparatus including:
an acquisition means for acquiring a first processing result that is a result of processing a target image using a first machine learning model, and acquiring a second processing result that is a processing result obtained by a high-precision image processing means capable of processing the target image with higher precision than the first machine learning model; and
a determination means for determining whether to use the target image as training data of the first machine learning model by using the first processing result and the second processing result.

2. The image selection apparatus according to the above 1, further including
a selection means for selecting the target image by using auxiliary information.

3. The image selection apparatus according to the above 1, wherein
the determination means determines whether to use the target image as the training data by further using auxiliary information.

4. The image selection apparatus according to the above 1, further including
a storage processing means for storing the target image determined to be used as the training data by the determination means and at least a part of the second processing result of the target image in a storage means as at least a part of the training data.

5. The image selection apparatus according to the above 2 or 3, wherein
the auxiliary information includes at least one of an image capturing location, an image capturing timing, and weather information during image capturing of the target image.

6. The image selection apparatus according to the above 2 or 3, wherein
the target image is generated by capturing an image of a road, and
the auxiliary information includes information on a situation of the road.

7. The image selection apparatus according to the above 2 or 3, wherein the auxiliary information is based on at least a part of the second processing result.

8. The image selection apparatus according to any one of the above 1 to 7, further including
a learning means for updating the first machine learning model by using the training data.

9. The image selection apparatus according to the above 7, wherein
the target image is generated by capturing an image of a road,
a plurality of image capturing means are arranged along the road,
the first processing result and the second processing result include presence or absence of a moving body,
the auxiliary information includes whether the moving body is detected in the second processing result related to an image generated at a predetermined timing by the image capturing means different from the image capturing means generating the target image in a case where the moving body is not detected in the second processing result related to the image capturing means generating the target image, and
the predetermined timing is a timing determined based on a generation timing of the target image.

10. The image selection apparatus according to the above 2 or 3, wherein
the auxiliary information includes information input via a user interface.

11. The image selection apparatus according to the above 4, wherein
the first processing result and the second processing result include presence or absence of a target object and a position of the target object, and
the at least part of the second processing result included in the training data includes the position of the target object.

12. The image selection apparatus according to any one of the above 1 to 11, wherein
a processing amount necessary for generating the second processing result is larger than a processing amount necessary for generating the first processing result,
the first processing result is generated each time the target image is generated, and
the second processing result is generated after the first processing result.

13. The image selection apparatus according to any one of the above 1 to 12, further including
the high-precision image processing means.

14. The image selection apparatus according to any one of the above 1 to 13, further including
a first image processing means for generating the first processing result.

15. An image selection method including:
acquiring, by at least one computer, a first processing result that is a result of processing a target image using a first machine learning model, and acquiring a second processing result that is a processing result obtained by high-precision image processing capable of processing the target image with higher precision than the first machine learning model; and
determining, by the at least one computer, whether to use the target image as training data of the first machine learning model by using the first processing result and the second processing result.

16. The image selection method according to the above 15, wherein
the at least one computer selects the target image by using auxiliary information.

17. The image selection method according to the above 15, wherein
the at least one computer determines whether to use the target image as the training data by further using auxiliary information.

18. The image selection method according to the above 15, wherein
the at least one computer stores the target image determined to be used as the training data and at least a part of the second processing result of the target image in a storage means as at least a part of the training data.

19. The image selection method according to the above 16 or 17, wherein
the auxiliary information includes at least one of an image capturing location, an image capturing timing, and weather information during image capturing of the target image.

20. The image selection method according to the above 16 or 17, wherein
the target image is generated by capturing an image of a road, and
the auxiliary information includes information on a situation of the road.

21. The image selection method according to the above 16 or 17, wherein
the auxiliary information is based on at least a part of the second processing result.

22. The image selection method according to any one of the above 15 to 21, wherein
the at least one computer updates the first machine learning model by using the training data.

23. The image selection method according to the above 21, wherein
the target image is generated by capturing an image of a road,
a plurality of image capturing means are arranged along the road,
the first processing result and the second processing result include presence or absence of a moving body,
the auxiliary information includes whether the moving body is detected in the second processing result related to an image generated at a predetermined timing by the image capturing means different from the image capturing means generating the target image in a case where the moving body is not detected in the second processing result related to the image capturing means generating the target image, and
the predetermined timing is a timing determined based on a generation timing of the target image.

24. The image selection method according to the above 16 or 17, wherein
the auxiliary information includes information input via a user interface.

25. The image selection method according to the above 18, wherein
the first processing result and the second processing result include presence or absence of a target object and a position of the target object, and
the at least part of the second processing result included in the training data includes the position of the target object.

26. The image selection method according to any one of the above 15 to 25, wherein
a processing amount necessary for generating the second processing result is larger than a processing amount necessary for generating the first processing result,
the first processing result is generated each time the target image is generated, and
the second processing result is generated after the first processing result.

27. The image selection method according to any one of the above 15 to 26, wherein
the at least one computer performs the high-precision image processing.

28. The image selection method according to any one of the above 15 to 27, wherein
the at least one computer generates the first processing result.

29. A program for causing at least one computer to function as:
an acquisition means for acquiring a first processing result that is a result of processing a target image using a first machine learning model, and acquiring a second processing result that is a processing result obtained by high-precision image processing capable of processing the target image with higher precision than the first machine learning model; and
a determination means for determining whether to use the target image as training data of the first machine learning model by using the first processing result and the second processing result.

30. The program according to the above 29, further causing
the at least one computer to function as a selection means for selecting the target image by using auxiliary information.

31. The program according to the above 29, wherein
the determination means further determines whether to use the target image as the training data by further using auxiliary information.

32. The program according to the above 29, further causing
the at least one computer to function as a storage processing means for storing the target image determined to be used as the training data by the determination means and at least a part of the second processing result of the target image in a storage means as at least a part of the training data.

33. The program according to the above 30 or 31, wherein
the auxiliary information includes at least one of an image capturing location, an image capturing timing, and weather information during image capturing of the target image.

34. The program according to the above 30 or 31, wherein
the target image is generated by capturing an image of a road, and
the auxiliary information includes information on a situation of the road.

35. The program according to the above 30 or 31, wherein
the auxiliary information is based on at least a part of the second processing result.

36. The program according to any one of the above 29 to 35, further causing
the at least one computer to function as a learning means for updating the first machine learning model by using the training data.

37. The program according to the above 35, wherein
the target image is generated by capturing an image of a road,
a plurality of image capturing means are arranged along the road,
the first processing result and the second processing result include presence or absence of a moving body,
the auxiliary information includes whether the moving body is detected in the second processing result related to an image generated at a predetermined timing by the image capturing means different from the image capturing means generating the target image in a case where the moving body is not detected in the second processing result related to the image capturing means generating the target image, and
the predetermined timing is a timing determined based on a generation timing of the target image.

38. The program according to the above 30 or 31, wherein
the auxiliary information includes information input via a user interface.

39. The program according to the above 32, wherein
the first processing result and the second processing result include presence or absence of a target object and a position of the target object, and
the at least part of the second processing result included in the training data includes the position of the target object.

40. The program according to any one of the above 29 to 39, wherein
a processing amount necessary for generating the second processing result is larger than a processing amount necessary for generating the first processing result,
the first processing result is generated each time the target image is generated, and
the second processing result is generated after the first processing result.

41. The program according to any one of the above 29 to 40, further causing
the at least one computer to function as a high-precision image processing means for performing the high-precision image processing.

42. The program according to any one of the above 29 to 41, further causing
the at least one computer to function as a first image processing means for generating the first processing result.

43. A recording medium storing the program according to any one of the above 29 to 42.

### REFERENCE SIGNS LIST

10 image processing apparatus
20 image selection apparatus
30 imaging apparatus
40 first storage unit
50 second storage unit
60 learning apparatus
110 first image processing unit
210 high-precision image processing unit
220 acquisition unit
230 determination unit
240 storage processing unit
250 selection unit
610 learning unit

What is claimed is:

1. An image selection apparatus comprising:
acquiring a first processing result that is a result of processing a target image using a first machine learning model, and acquiring a second processing result that is a processing result obtained by a high-precision image processing capable of processing the target image with higher precision than the first machine learning model; and
determining whether to use the target image as training data of the first machine learning model by using the first processing result and the second processing result.

2. The image selection apparatus according to claim 1, further comprising
selecting the target image by using auxiliary information.

3. The image selection apparatus according to claim 1, wherein
determining whether to use the target image as the training data by further using auxiliary information.

4. The image selection apparatus according to claim 1, further comprising
storing the target image determined to be used as the training data by the determining and at least a part of the second processing result of the target image in a storage as at least a part of the training data.

5. The image selection apparatus according to claim 2, wherein
the auxiliary information includes at least one of an image capturing location, an image capturing timing, and weather information during image capturing of the target image.

6. The image selection apparatus according to claim 2, wherein
the target image is generated by capturing an image of a road, and
the auxiliary information includes information on a situation of the road.

7. The image selection apparatus according to claim 2, wherein
the auxiliary information is based on at least a part of the second processing result.

8. The image selection apparatus according to claim 1, further comprising
updating the first machine learning model by using the training data.

9. The image selection apparatus according to claim 7, wherein
the target image is generated by capturing an image of a road,
a plurality of image capturing apparatuses are arranged along the road,
the first processing result and the second processing result include presence or absence of a moving body,
the auxiliary information includes whether the moving body is detected in the second processing result related to an image generated at a predetermined timing by the image capturing apparatuses different from the image capturing apparatuses generating the target image in a case where the moving body is not detected in the second processing result related to the image capturing apparatuses generating the target image, and
the predetermined timing is a timing determined based on a generation timing of the target image.

10. The image selection apparatus according to claim 2, wherein
the auxiliary information includes information input via a user interface.

11. The image selection apparatus according to claim 4, wherein
the first processing result and the second processing result include presence or absence of a target object and a position of the target object, and
the at least part of the second processing result included in the training data includes the position of the target object.

12. The image selection apparatus according to claim 1, wherein
a processing amount necessary for generating the second processing result is larger than a processing amount necessary for generating the first processing result,
the first processing result is generated each time the target image is generated, and
the second processing result is generated after the first processing result.

13. The image selection apparatus according to claim 1, further comprising
performing the high-precision image processing.

14. The image selection apparatus according to claim 1, further comprising
generating the first processing result.

15. An image selection method comprising:
acquiring, by at least one computer, a first processing result that is a result of processing a target image using a first machine learning model, and acquiring a second processing result that is a processing result obtained by high-precision image processing capable of processing the target image with higher precision than the first machine learning model; and
determining, by the at least one computer, whether to use the target image as training data of the first machine learning model by using the first processing result and the second processing result.

16. A non-transitory computer-readable storage medium storing a program for causing at least one computer to function as:
acquiring a first processing result that is a result of processing a target image using a first machine learning model, and acquiring a second processing result that is a processing result obtained by high-precision image processing capable of processing the target image with higher precision than the first machine learning model; and
determining whether to use the target image as training data of the first machine learning model by using the first processing result and the second processing result.
